(19) United States
(12) Patent Application Publication
(10) Pub. No.: US 2014/0136270 A1
(43) Pub. Date: May 15, 2014

(54) ACQUISITION ROADMAPPING TOOL

(71) Applicant: AVIAN ENGINEERING LLC, Lexington Park, MD (US)

(72) Inventor: Kevin G. Switick, Lexington Park, MD (US)

(73) Assignee: AVIAN ENGINEERING LLC, Lexington Park, MD (US)

(21) Appl. No.: 13/674,205

(22) Filed: Nov. 12, 2012

(51) Int. Cl. G06Q 10/06

(52) U.S. Cl. CPC G06Q 10/06313
USPC 705/7.23

(57) ABSTRACT

Various exemplary embodiments relate to a method of developing a cost estimate for a requirement applicable to one or more acquisition programs. The method may include receiving an indication of a requirement time frame, one or more applicable acquisition programs, and one or more work locations; documenting a source of the requirement; documenting a funding source for the requirement; generating one or more plans based on the time frame, applicable acquisition programs, and work locations, each plan requesting a non-cost estimate and information to support the estimate; receiving input into each of the generated plans; generating a plurality of cost entry sheets based on the time frame, applicable acquisition programs, and the received plan input; receiving cost estimates from the cost entry sheets; and generating an estimate of expenses applied to the funding source during the time frame.

### TECHNICAL FIELD

Various exemplary embodiments disclosed herein relate generally to acquisition and cost estimation.

### BACKGROUND

In the acquisition of new systems, U.S. government agencies and departments are required to develop detailed cost estimates prior to the release of contracts to industry. Within the Department of Defense (DOD), these cost estimates feed the Planning, Programming, Budgeting and Execution (PPBE) process. The objectives of this process are to produce, submit for approval, and then execute fiscally responsible investment strategies that balance current mission readiness with future mission capability upgrades.

### SUMMARY

The generation of initial estimates is often the realm of a Product Team Lead within Department of the Navy (DON) Program Offices. Development of these initial estimates by the Product Team Lead can be a lengthy process which begins with the creation of a cost data sheet outlining all the required cost elements needed for the effort, including product development, procurement, installation, test & evaluation, logistics and supportability elements, training systems, spare components and parts, etc. It is important that the data underlying the development of these initial cost estimates be comprehensive with well-documented assumptions. Failure to capture all relevant cost elements and their associated assumptions can result in underfunded, un-executable programs.

Professional cost estimators are often employed to use sophisticated tools to generate estimates for large projects as they near completion. However, in some cases, cost estimates need to be generated by personnel who are not only non-professionals in cost estimating techniques, but often inexperienced in the overall budgetary process. Historically, some Program Offices have created processes to guide Integrated Product Team (IPT) leaders, but in many other cases there is no guidance beyond some verbal instruction and tribal knowledge provided via On-the-Job Training. Even where such processes exist they are inconsistently applied, usually because they involve unique, customized spreadsheets originally created as a point solution to a problem. Another difficulty arises when an issue that was not selected for funding in a given year is brought forward again during the subsequent annual budget cycle. In few cases is there documentation of estimates and underlying assumptions, resulting in the need to completely re-create the estimate. Due to inexperience, it is common for junior, inexperienced IPT leaders to overlook one or more significant cost factors while creating an estimate. All of these factors lead to extensive rework as more experienced, higher-echelon supervisors and professional cost estimators review the cost estimates and discover cost element gaps and poor assumptions (or worse yet, fail to uncover faulty assumptions that were not properly documented).

In view of the foregoing, it would be desirable to provide a tool to assist in developing an initial cost estimate. In particular, it would be desirable to provide a tool that helps an estimator determine what information is required and document assumptions that are used to generate the initial cost estimate.

In light of the present need for a cost estimate tool, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of developing a cost estimate for a requirement applicable to one or more acquisition programs. The method may include: receiving an indication of a requirement time frame, one or more applicable acquisition programs, and one or more work locations; documenting a source of the requirement; documenting a funding source for the requirement; generating one or more plans based on the time frame, applicable acquisition programs, and work locations, each plan requesting a non-cost estimate and information to support the estimate; receiving input into each of the generated plans; generating a plurality of cost entry sheets based on the time frame, applicable acquisition programs, and the received plan input; receiving cost estimates from the cost entry sheets; and generating an estimate of expenses applied to the funding source during the time frame.

In various embodiments, the input plans include at least one of: a manpower plan, an installation plan, a training system plan, a test and evaluation plan, and a logistics plan.

In various embodiments, the input plan includes selectable training for the estimate or the information to support the estimate.

In various embodiments, the method further includes dynamically customizing at least one of the plans based on input received into the at least one plan.

In various embodiments, the method further includes establishing permission for a plurality of users allowed to edit a requirement estimate; receiving input from the plurality of allowed users; and combining the input from the plurality of allowed users to generate a single estimate.

In various embodiments, the method further includes storing a plurality of versions of the cost estimate for a requirement.

In various embodiments, the acquisition programs are aircraft models, aircraft sub-components, avionics systems, sensor systems, or weapon systems, and the estimate includes a forward fit estimate and a retro fit estimate.

In various embodiments, the method further includes receiving a level of confidence for a cost estimate.

In various embodiments, the method further includes documenting a plurality of funding sources for the requirement, wherein at least one of the plurality of cost entry sheets includes a table for estimating costs by funding source.

Various exemplary embodiments relate to a cost estimate tool. The cost estimate tool includes: a requirements entry screen comprising input fields for a requirement start date, a requirement time span, a plurality of potential acquisition programs, a plurality of locations, a requirement source, and a funding source; a plurality of plan screens generated based on input entered into the requirements entry screen, each plan screen including at least one input field for entering a non-cost estimate and at least one input field for entering an assumption related to the non-cost estimate; a cost entry screen generated based on input received from the requirements entry screen and the plurality of plan screens, the cost entry screen including a set of input fields for each acquisition program; and an estimate generator configured to generate an estimated cost for a plurality of time periods within the time span and documented assumptions upon which the estimated cost is based.

In various embodiments, the plan screens include at least one of: a manpower plan, a procurement plan, an installation plan, a training system plan, a test and evaluation plan, and a logistics plan.

In various embodiments, wherein at least one of the requirements entry screen, plan entry screens, and cost entry screens includes selectable training for the estimate or the information to support the estimate.

In various embodiments, at least one of the plans is dynamically customized based on input received into the at least one plan.

In various embodiments, the cost estimate tool further includes a user management engine configured to establish permissions for a plurality of users allowed to edit a requirement estimate, wherein the estimate generator is further configured to: receive input from the plurality of allowed users; and combine the input from the plurality of allowed users to generate a single estimate.

In various embodiments, the cost estimate tool further includes a database configured to store a plurality of versions of the cost estimate for a requirement.

In various embodiments, the acquisition programs are aircraft models, aircraft sub-components, avionics systems, sensor systems, or weapon systems; and the estimate includes a forward fit estimate and a retro fit estimate.

In various embodiments, a cost entry screen includes an input field for receiving a level of confidence for a cost estimate.

In various embodiments, when a plurality of funding sources are input into the requirements screen, at least one of the plurality of cost entry screens includes a table for estimating costs by funding source.

Various embodiments relate to a non-transitory machine-readable storage medium encoded with instructions executable by a processor. The non-transitory machine-readable storage medium includes: instructions for receiving an indication of a requirement time frame, one or more applicable acquisition programs, and one or more work locations; instructions for documenting a source of the requirement; instructions for documenting a funding source for the requirement; instructions for generating one or more plans based on the time frame, applicable acquisition programs, and work locations, each plan requesting a non-cost estimate and information to support the estimate; instructions for receiving input into each of the generated plans; instructions for generating a plurality of cost entry sheets based on the time frame, applicable acquisition programs, and the received plan input; instructions for receiving cost estimates from the cost entry sheets; and instructions for generating an estimate of expenses applied to the funding source during the time frame.

It should be apparent that, in this manner, various exemplary embodiments enable a roadmapping acquisition tool. In particular, by guiding the input of a user, the acquisition roadmapping tool can ensure collection and documentation of information necessary to generating a cost estimate for a requirement.

### BRIEF DESCRIPTION OF THE DRAWINGS

In order to better understand various exemplary embodiments, reference is made to the accompanying drawings, wherein:

FIG. 1 illustrates an exemplary system for employing an acquisition roadmapping tool;

FIG. 2 illustrates a flowchart showing an exemplary method that may be performed by an acquisition roadmapping tool;

FIG. 3 illustrates an exemplary user interface for using an acquisition roadmapping tool;

FIG. 4 illustrates another exemplary user interface of the acquisition roadmapping tool for entering plan information;

FIG. 5 illustrates another exemplary user interface of the acquisition roadmapping tool for entering plan information;

FIG. 6 illustrates an exemplary user interface of the acquisition roadmapping tool for entering cost data;

FIG. 7 illustrates another exemplary user interface of the acquisition roadmapping tool for entering cost data; and

FIG. 8 illustrates an exemplary user interface of the acquisition roadmapping tool for displaying results.

### DETAILED DESCRIPTION

Referring now to the drawings, in which like numerals refer to like components or steps, there are disclosed broad aspects of various exemplary embodiments.

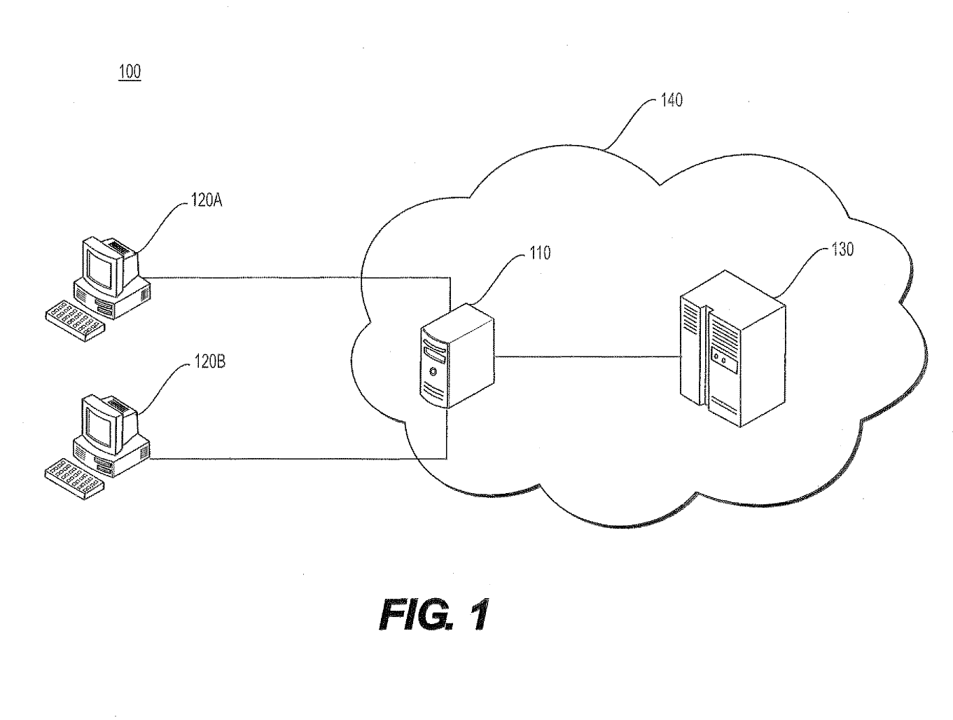

FIG. 1 illustrates an exemplary system 100 for employing an acquisition roadmapping tool. System 100 includes server 110, user devices 120, and database 130. The various components of system 100 may be linked together via a computer network such as, for example, the Internet. In various embodiments, various components, such as, for example, server 110 and database 130 may be provided as network services or web services. System 100 may use cloud computing and various components may be part of the cloud 140. Accordingly, components such as server 110 and database 130 may include one or more electronic computers and the functions performed by components such as server 110 and database 130 may be performed by one or more devices.

Server 110 may be a computer server providing an acquisition roadmapping tool as a web service. For example, server 110 may be an Apache web server or a Microsoft Internet Information Server. Server 110 may host the acquisition roadmapping tool and allow user devices 120 access to the tool. Server 110 may provide user authentication and access control for the tool, such that individual users are authorized to view and edit only information relevant to their projects. Server 110 may establish hierarchical user permissions to allow an organization to manage access to the tool. In various embodiments, server 110 may also include a user interface such that a user may access the roadmapping tool on server 110.

User devices 120 may include any devices capable of communicating with server 110 and interacting with a web service. For example, user devices 120 may include personal computers, laptop computers, tablet computers, cell phones, smart phones, or any other device supporting web services. A user device 120 may include an application for accessing an acquisition roadmapping tool. A user device 120 may include one or more input devices such as, for example, a keyboard, mouse, touchpad, or touchscreen. An end user may operate a user device 120 in order to access the roadmapping tool. The user may input information into the roadmapping tool using the input device of user device 120. User device 120 may forward the input information to server 110 via the roadmapping tool.

Database 130 may store data related to the roadmapping tool. Database 130 may store completed estimates and estimates in progress. Database 130 may store multiple versions of an estimate, so that the roadmapping tool may allow a user to compare various estimates. Server 110 may update the stored estimate whenever a user navigates to a different sheet. Database 130 may also store requirements information used by the roadmapping tool. For example, database 130 may store information regarding various acquisition programs such as type/model/series (T/M/S) of various aircraft. Server 110 may use such information to generate specific questions and input fields for estimates related to particular acquisition programs.

Cloud 140 may represent functionality provided by a cloud service. For example, server 110 may be emulated by a cloud service. A cloud provider may use one or more servers to emulate server 110. Using a cloud service 140 may allow increased stability through redundancy, faster response times, lower cost, and convenient scaling.

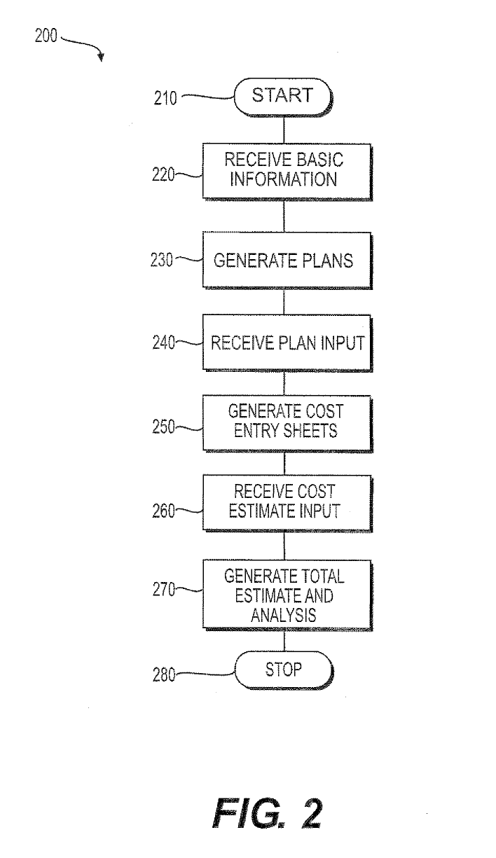

FIG. 2 illustrates a flowchart showing an exemplary method 200 that may be performed by server 110. Method 200 may begin at step 210 and proceed to step 220.

In step 220, server 110 may receive basic project information about an estimate for a requirement. The basic project information may include information such as a project title, project owner, start date, time span, and other general descriptive information. The basic information may also include initial selections of applicable acquisition programs, work locations, requirement sources, and funding sources. In various exemplary embodiments, requirements may relate to requirements for government acquisition programs such as military acquisitions. However, it should be apparent that the described system and method may be applicable to generate cost estimates in other environments having structured requirements. For example, the acquisition roadmapping tool and method may be adapted to generate estimates for complying with business or industry requirements. Once the server 110 has acquired the basic project information, the method 200 may proceed to step 230.

In step 230, server 110 may generate one or more input plans based on the basic information. Each input plan may be a customized form to receive input relevant to the estimate for the requirement. An input plan may include one or more fields for receiving a non-cost estimate for the requirement. For example, a manpower plan may include a field for entering an estimated number of man-hours required for the requirement. In various embodiments, the input plans include a manpower plan, an installation plan, a training systems plan, a test and evaluation (T&E) plan, and a logistics plan. The input plans may also include a generic plan, other considerations, or additional input fields that do not fit within a particular plan. It should be apparent that the various input plans may be combined or divided.

In step 240, server 110 may receive plan input. The plan input may include one or more completed input plan forms. Server 110 may perform validity checks on the input plan forms to ensure that forms have been completed and that the information conforms to required formats. Server 110 may also determine whether the input data includes internal inconsistencies or the data is inconsistent with previous estimates. Server 110 may notify user device 120 of potential errors and require correction before proceeding. Server 110 may forward the received data to database 130.

In step 250, server 110 may generate cost entry sheets. A cost entry sheet may include a plurality of fields for entering estimated costs. In various embodiments, a cost entry sheet may include one or more tables. Server 110 may customize the one or more tables based on the basic information and the plan input. For example, server 110 may generate tables based on: plan requirements, time span, selected acquisition programs, selected work locations, selected funding sources, and projected start date for the project to consider inflation. The cost entry sheets may be hierarchical. In various embodiments, server 110 may generate a set of cost entry sheets for each selected acquisition program. A set of cost entry sheets for an acquisition program may include a cost entry sheet for one or more plans, as well as other types of costs. For example, a set of cost entry sheets may include: non-recuring costs, recurring costs, training systems costs, T&E costs, logistics costs, and ancillary costs. A cost entry sheet may include one or more tables for entering costs. A table may include columns corresponding to fiscal years and rows corresponding to selected funding sources. Another cost entry sheet may include a table for entering costs for an individual expense and a table for entering a quantity of individual expenses within a fiscal year. Server 110 may also generate sheets for entering additional information to support the cost estimates. For example, server 110 may generate a sheet for documenting the source of the estimates and determining a confidence level.

In step 260, server 110 may receive cost estimate data entered into the cost entry sheets. Server 110 may perform validity checks on the cost entry sheets to ensure that forms have been completed and that the information conforms to required formats. Server 110 may also determine whether the input data includes internal inconsistencies. Server 110 may notify user device 120 of potential errors and require correction before proceeding. Server 110 may forward the received data to database 130.

In step 270, server 110 may generate a total estimate and generate one or more reports. Server 110 may generate the total estimate by summing individual cost estimates and applying a cost escalation factor. In various embodiments, different cost escalation factors may be used to provide varying estimates based on different cost escalation assumptions. The one or more reports may present cost estimate information in a manner that facilitates understanding or decision making. For example, an executive summary report may show costs according to plans and fiscal years. As another example, a detailed report may present cost estimates as well as information and assumptions supporting the cost estimate.

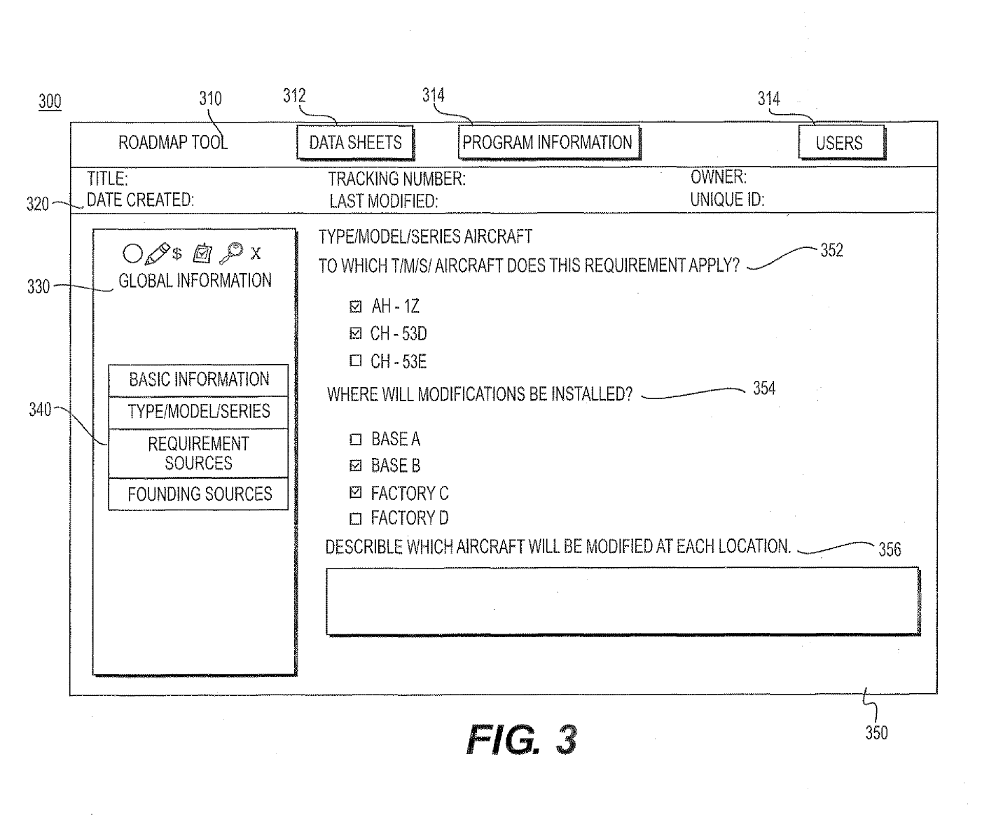

FIG. 3 illustrates an exemplary user interface 300 for using an acquisition roadmapping tool. User interface 300 may include one or more fields for presenting information and navigation options. Although one possible configuration for various fields is shown in FIG. 3, it should be apparent that fields may be added, deleted, or rearranged. User interface 300 may include a title bar 310, basic information display 320, operation buttons 330, navigation buttons 340, and main field 350.

Title bar 310 may include a name of a software roadmapping tool. The title bar may also include buttons or links to system level interfaces. In addition to providing an activatable button or link, buttons may indicate the current interface. For example, button 312 may be used to navigate to an interface, such as interface 300, for filling data sheets. Button 312 may be shown as activated to indicate that the current interface is for filling data sheets. Button 314 may be used to navigate to an interface for entering program information such as funding sources and work locations related to various acquisition programs. Button 316 may be used to navigate to a user management interface for controlling users who have access to the roadmapping tool.

Basic information display 320 may include basic information about a current estimate. The basic information may be repeated on various interfaces related the current estimate, so that it is readily accessible and may be used to identify the current estimate. Basic information may include a title, tracking number, owner, date created, date last modified, and unique identifier.

Operation buttons 330 may be used to navigate to various tasks for the current estimate. For example, operation buttons 330 may include buttons for global information sheets, plan sheets, cost entry sheets, executive summary output, detailed output, and exiting the tool.

Navigation buttons 340 may be used to navigate to specific sheets within a category, such as global information. The navigation buttons 340 may correspond to individual sheets within a current category. For example, navigation buttons 340 for a global information category may include a basic information sheet, a type/model/series information sheet, a requirement sources sheet, and a funding sources sheet.

Main field 350 may provide a space for presenting a data input sheet to be filled by a user. The data input sheet may present a series of questions to be answered by the user. A question may include different options for answering the question. Options may be generated according to data entered into the current data sheet, other sheets for the current estimate, or interfaces for entering universal data applicable to multiple estimates. For example, question 352 may ask to which aircraft, or acquisition program, a requirement applies. The options to answer question 352 may be generated based on universal information entered into a different interface, such as, for example, a program information interface accessible through button 314. As another example, question 354 may ask where modifications to comply with the requirement will be made. The options to answer question 354 may be generated based on universal information entered for locations. As a third example, question 356 may ask the user to describe which aircraft will be modified at each location. The interface 300 may provide a generic text box for answering a more open ended question such as question 356. The text box may provide basic text editing tools as well as well as formatting tools.

The interface 300 may present various main fields 350 based on the navigation button 340 that is selected by the user. For example, a basic information main field may ask the user to enter a document title, issue owner, start year, project time span, and short description. As another example, a requirement sources main field may present options for indicating the source of the requirement. Each source may be associated with additional questions based on contracts and regulations governing the particular requirement source. As yet another example, a funding sources main field may present options for indicating various funding sources that may be used to fund the project. Multiple funding sources may be selected, and a text box may be provided to allow explanation.

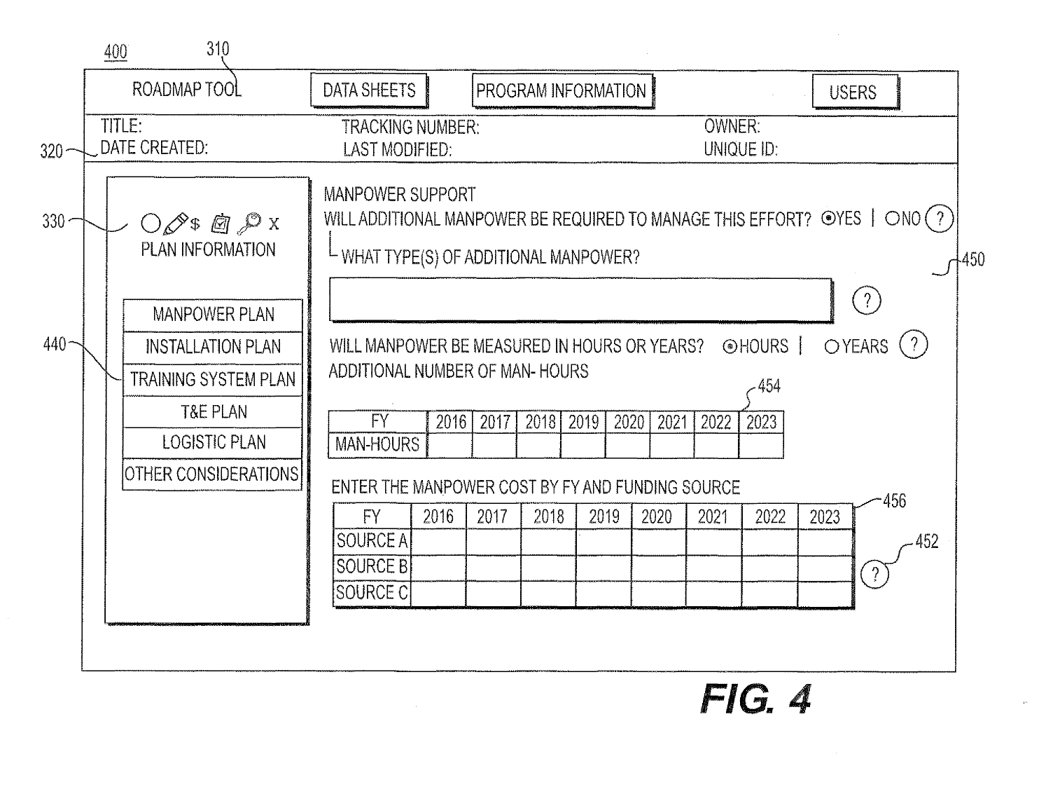

FIG. 4 illustrates another exemplary user interface 400 of the acquisition roadmapping tool for entering plan information. User interface 400 may include similar fields to user interface 300 such as, for example, title bar 310, basic information display 320, and operation buttons 330. User interface 400 may include a different set of navigation buttons 440 and different main field 450.

Navigation buttons 440 may provide for navigation between various plan information sheets. Plan information sheets may include a manpower plan, an installation plan, a training system plan, a T&E plan, and a logistics plan. Navigation buttons 440 may also include a miscellaneous or other considerations sheet.

Main field 450 may provide a space for presenting a data input sheet to be filled by a user. The data input sheet may present a series of questions to be answered by the user. For example, a manpower plan may ask whether additional manpower will be required, what type of manpower, how manpower will be measured, and cost and source of funding for manpower. Main field 450 may provide various tools to assist in completing a plan data input sheet.

Main field 450 may include help button 452. When selected, help button 452 may provide specific directions for answering the question. Database 130 may store the directions associated with each question. In addition to directions, help button 452 may provide useful information such as equations, standards, and rough estimates. For example, help button 452 may provide information for filling in answer table 456, such as man-hours per year and salary estimates based on level of experience.

Main field 450 may include an answer table 454. An answer table may be sized according to data entered into the current data sheet, other sheets for the current estimate, or interfaces for entering universal data applicable to multiple estimates. For example, answer table 454 may be based on the project start year and project time span entered in a basic information page. As another example, answer table 456 may be based on the project start year and project time span entered in a basic information sheet as well as the funding sources selected on a funding source sheet.

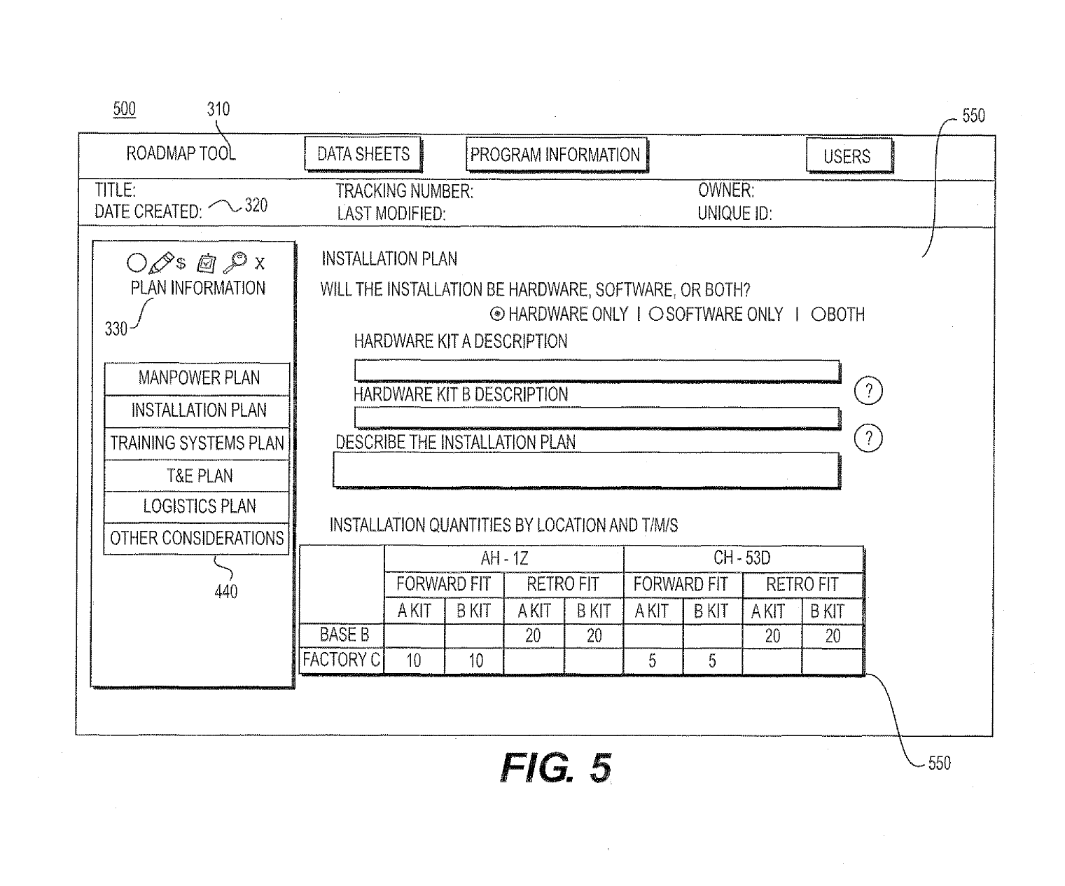

FIG. 5 illustrates another exemplary user interface 500 of the acquisition roadmapping tool for entering plan information. User interface 500 may include similar information as user interface 400 in title bar 310, basic information display 320, operations buttons 330, and navigation buttons 440. Interface 500 may include main field 550 for entering an installation plan.

Main field 550 may include complex input table 552. For example, input table 552 may include columns for selected acquisition programs, as well as forward fit and retro fit installations, and A kits and B kits. The columns may be based on the selected acquisition programs as well as information stored for each acquisition program. Input table 552 may also include rows based on the selected work locations. Main field 550 may also ask for descriptions of the A kit and B kit, a description of the installation plan, non-recurring engineering costs for the installation, descriptions of forward and retro fit installation, specific units or effectivities to be modified, and necessary advance procurement.

Interface 400 or 500 may present additional plan input sheets based on the selected navigation button 440. For example, a training systems plan may ask for additions and changes to training systems, specific trainers to upgrade, required training system courseware, and other training system impacts. As another example, a test and evaluation plan may ask for a description of required test and evaluation procedures, whether and how many additional kits are necessary for test and evaluation, whether particular regulations and programs need to be satisfied, test facilities such as laboratories, ranges, and ships to be used, and test instruments to be used. A logistics plan may ask for a general description, whether publications need to be updated, whether and what type of peculiar support equipment needs to be developed, whether and what type of ground support equipment is necessary, and other logistics changes. Other considerations that may be presented in a separate sheet include whether the requirement will drive production engineering, whether ancillary requirements are related to the current estimate, and additional space for comments and uncategorized expenses.

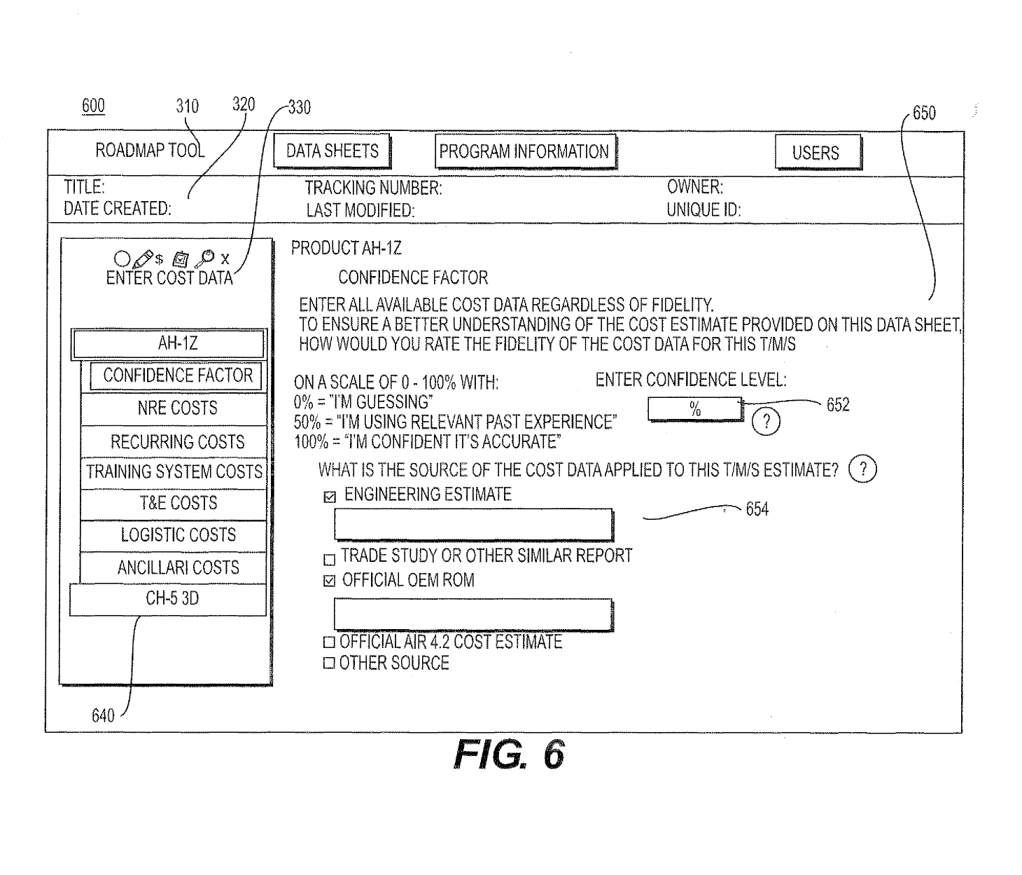

FIG. 6 illustrates an exemplary user interface 600 of the acquisition roadmapping tool for entering cost data. User interface 600 may include similar information as user interface 300 in title bar 310, basic information display 320, and operations buttons 330. User interface 600 may include hierarchical navigation buttons 640 and main field 650 for entering confidence data.

Hierarchical navigation buttons 640 may allow a user to navigate among various cost entry data sheets. A set of cost entry data sheets may be generated for each acquisition program. When a user selects an acquisition program, the hierarchical navigation buttons 640 may change to display buttons for cost types within the set for the acquisition program. Accordingly, the acquisition program may be a top level of the hierarchy and the cost types may be a second level. Additional levels of data sheets may be included for more complex cost types. The hierarchical navigation buttons may also include buttons to switch hierarchy levels.

Main field 650 may provide a form for inputting confidence information. A user may enter a confidence level 652 as a percentage. Main field 650 may provide guidelines for determining a confidence level. Allowing a confidence level may encourage a user to document all costs even if uncertain. Confidence information may also be useful for someone reviewing the estimate. Main field 650 may also ask for a source of the cost data 654 used to generate the estimates. Options to select various sources may be provided. When an estimate source is selected, main field 650 may present additional space for documenting the source. In various embodiments, the roadmapping tool may generate a confidence factor automatically based on selected and/or documented estimate sources.

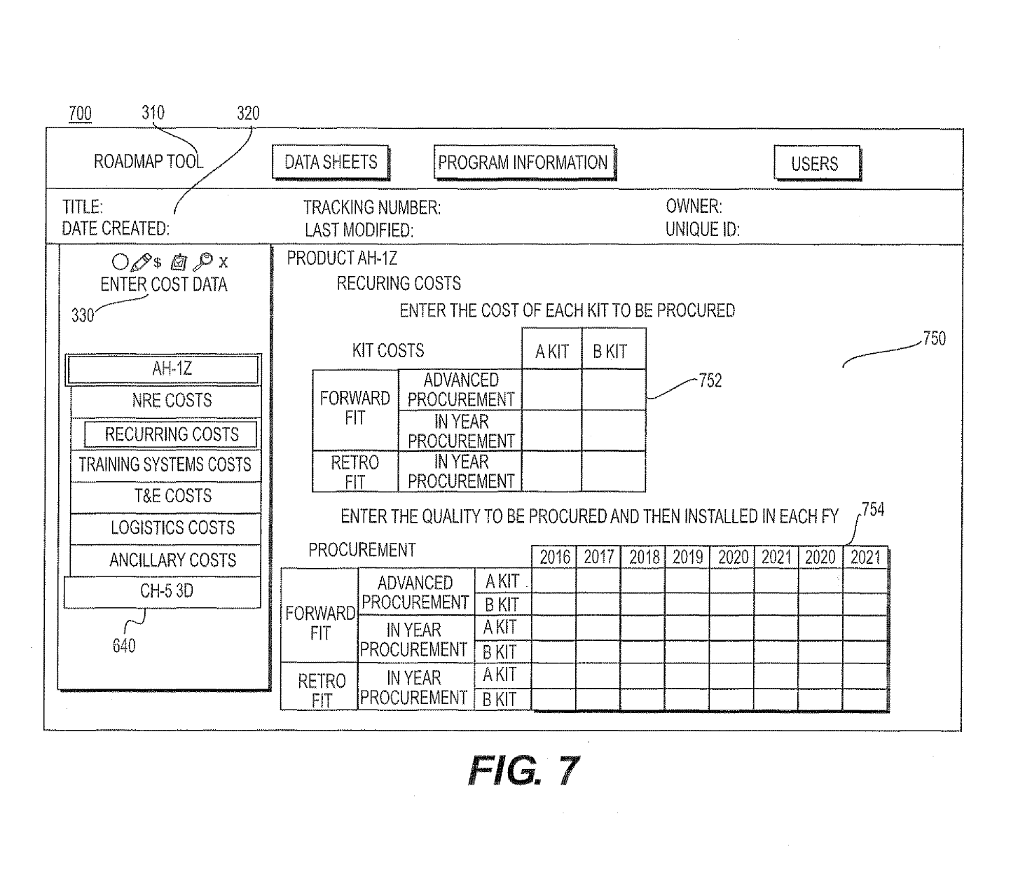

FIG. 7 illustrates an exemplary user interface 700 of the acquisition roadmapping tool for entering cost data. User interface 700 may include similar information as user interface 300 in title bar 310, basic information display 320, and operations buttons 330. User interface 700 may include hierarchical navigation buttons 640 similar to user interface 600. User interface 700 may include main field 750 for entering cost data.

Main field 750 may include one or more individual cost tables 752 and one or more cost quantity tables 752. An individual cost table 752 may include cells to enter costs for various components procured in various situations. For example, a component such as an A kit, may be more expensive to procure in the current year than it would be if obtained further in advance. The roadmapping tool may generate the individual cost table 752 dynamically based on information provided in general information and/or plan data sheets. A cost quantity table 752 may include a plurality of cells for entering estimated quantities required per year. Main field 750 may include additional tables such as, an installation cost table for entering install costs by location and an installation quantity table for entering installation quantities by location per year.

Although main field 750 is shown for recurring costs, other navigation buttons may direct to an interface for entering costs into tables. Tables may be further organized into additional hierarchical levels. Test and evaluation (T&E) costs may include various tests that must be performed in each year. Accordingly, T&E cost entry tables may be organized by funding source, in addition to acquisition unit and cost type. Additional types of cost entry sheets may include non-recurring engineering (NRE) costs, training system costs, logistics costs, and ancillary costs. NRE costs may include a cost table for entering one-time costs for each funding source per year training systems costs may include a cost table for entering training costs for each funding source per year. Logistics costs may include tables for publications and other costs by funding source and year. Ancillary costs may include tables for production engineering or any additional costs generated by the requirement.

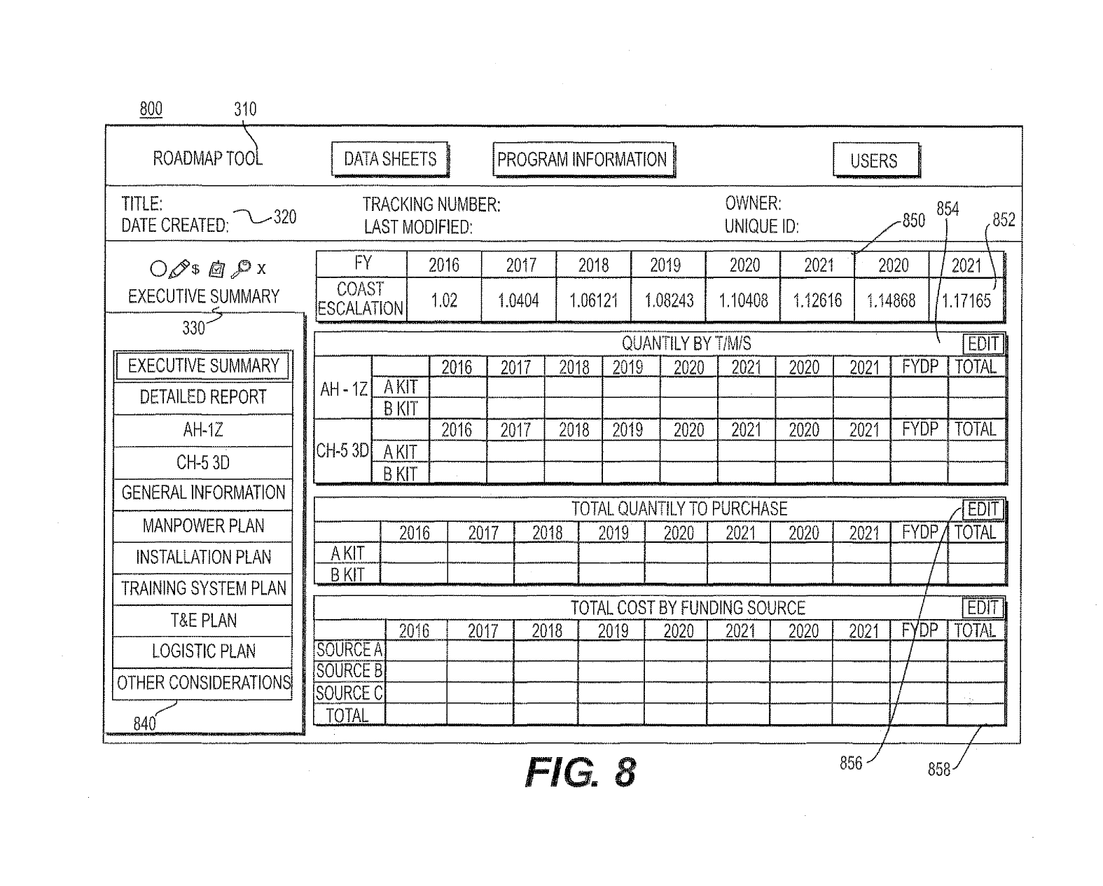

FIG. 8 illustrates an exemplary output interface 800 of the acquisition roadmapping tool. Output interface 800 may include similar information as user interface 300 in title bar 310, basic information display 320, and operations buttons 330. User interface 800 may also include output navigation buttons 840 and output display field 850.

Output navigation buttons 840 may provide for navigation within an output of the acquisition roadmapping tool. The navigation buttons 840 may be arranged in a hierarchal manner with each level providing a greater level of detail. Individual buttons of the navigation buttons 840 may cause output field 850 to display information related to the selected button. For example, output navigation buttons may be provided for an executive summary and detailed analysis. The detailed analysis button may provide additional buttons for each acquisition program, general information, a manpower plan, an installation plan, a training systems plan, a T&E plan, a logistics plan, and other considerations.

Output field 850 may present both input and calculated information. Information may appear in the form of tables such as escalation table 852, quantity table 854, total quantity table 856, and total cost table 858. Output field 850 may also include tables for displaying any other information available to the acquisition roadmapping tool.

Escalation table 852 may display a cost escalation that has been applied to each successive year during a project time frame. A cost escalation may be due to inflation. In various embodiments, the cost escalation may be based on a simple assumed inflation rate such as, for example, 2 percent. Any other model for predicting inflation may be used. The acquisition roadmapping tool may automatically apply the cost escalation to estimated costs.

Quantity table 854 may display a quantity of acquired units by acquisition program, which may be referred to as type/model/series (T/M/S). The quantity may be displayed according to acquisition program, type of kit, and fiscal year. Quantity table 854 may further include both a future year defense program (FYDP) estimate and a total estimate. The FYDP and total estimate may vary based on accounting methods. Quantity table 854 may also include an EDIT button. The EDIT button may return the user to an input interface upon which the table is based.

Total quantity table 856 may display a total quantity of units to purchase during each fiscal year. Total quantity table 856 may also display both a FYDP estimate and a total estimate. Total quantity table 856 may also include an EDIT button.

Total cost table 858 may display the total cost for each fiscal year. The total cost may also be displayed according to funding source. The costs may be displayed in a convenient multiple. For example, in various embodiments, costs may be displayed in millions of dollars. Total cost table 858 may also display both a FYDP estimate and a total estimate. Total cost table 858 may also include an EDIT button.

Output field 850 may include additional information, which may also be displayed as tables. For example, output field 850 may include a table for each plan or for each input table. An information cost table may display installation costs for the requirement for each financial year per funding source. A recurring cost table may display recurring costs for the requirement for each fiscal year per funding source for both forward fit and retro fit installations. A total recurring costs table may sum all recurring costs. A non-recurring engineering costs table may display non-recurring engineering costs for each fiscal year per funding source and a total. A training cost table may display the training cost for each fiscal year per funding source and a total. A T&E table may display test and evaluation costs for each fiscal year per funding source and a total. A logistics table may display logistics costs for each fiscal year per funding source and a total. An ancillary table may display ancillary and other costs for each fiscal year per funding source and a total. A manpower costs table may display manpower costs for each fiscal year per funding source and a total.

Output field 850 may also display assumptions and other information to support the estimates. For example, a detailed report may include answers to any question of the input interfaces. The information may be formatted within output field 850 and displayed along with a corresponding output table.

According to the foregoing, various exemplary embodiments provide for an acquisition roadmapping tool for cost estimation. In particular, by guiding the input of a user, the acquisition roadmapping tool can ensure collection and documentation of information necessary to generating a cost estimate for a requirement.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of developing a cost estimate for a requirement applicable to one or more acquisition programs, the method comprising:
receiving an indication of a requirement time frame, one or more applicable acquisition programs, and one or more work locations;
documenting a source of the requirement;
documenting a funding source for the requirement;
generating one or more plans based on the time frame, applicable acquisition programs, and work locations, each plan requesting a non-cost estimate and information to support the estimate;
receiving input into each of the generated plans;
generating a plurality of cost entry sheets based on the time frame, applicable acquisition programs, and the received plan input;
receiving cost estimates from the cost entry sheets; and
generating an estimate of expenses applied to the funding source during the time frame.

2. The method of claim 1, wherein the input plans include at least one of a manpower plan, an installation plan, a training system plan, a test and evaluation plan, and a logistics plan.

3. The method of claim 1, wherein the input plan includes selectable training for entering a cost estimate or information to support the estimate.

4. The method of claim 1, further comprising dynamically customizing at least one of the plans based on input received into the at least one plan.

5. The method of claim 1, further comprising:
establishing permission for a plurality of users allowed to edit a requirement estimate;
receiving input from the plurality of allowed users; and
combining the input from the plurality of allowed users to generate a single estimate.

6. The method of claim 1, further comprising:
storing a plurality of versions of the cost estimate for a requirement.

7. The method of claim 1, wherein the acquisition programs are aircraft models and the estimate includes a forward fit estimate and a retro fit estimate.

8. The method of claim 1, further comprising receiving a level of confidence for a cost estimate.

9. The method of claim 1, further comprising documenting a plurality of funding sources for the requirement, wherein at least one of the plurality of cost entry sheets includes a table for estimating costs by funding source.

10. A cost estimate tool comprising:
a requirements entry screen comprising input fields for a requirement start date, a requirement time span, a plurality of potential acquisition programs, a plurality of locations, a requirement source, and a funding source;
a plurality of plan screens generated based on input entered into the requirements entry screen, each plan screen including at least one input field for entering a non-cost estimate and at least one input field for entering an assumption related to the non-cost estimate;
a cost entry screen generated based on input received from the requirements entry screen and the plurality of plan screens, the cost entry screen including a set of input fields for each acquisition program; and
an estimate generator configured to generate an estimated cost for a plurality of time periods within the time span and documented assumptions upon which the estimated cost is based.

11. The cost estimate tool of claim 10, wherein the plan screens include at least one of: a manpower plan, an installation plan, a training system plan, a test and evaluation plan, and a logistics plan.

12. The cost estimate tool of claim 10, wherein at least one of the requirements entry screen, plan entry screens, and cost entry screens includes selectable training for entering the non-cost estimate or for filling an input field.

13. The cost estimate tool of claim 10, wherein at least one of the plans is dynamically customized based on input received into the at least one plan.

14. The cost estimate tool of claim 10, further comprising:
a user management engine configured to establish permissions for a plurality of users allowed to edit a requirement estimate, wherein the estimate generator is further configured to:
receive input from the plurality of allowed users; and
combine the input from the plurality of allowed users to generate a single estimate.

15. The cost estimate tool of claim 10, further comprising:
a database configured to store a plurality of versions of the cost estimate for a requirement.

16. The cost estimate tool of claim 10, wherein one of the acquisition programs is directed to acquisition of aircraft models, aircraft sub-components, avionics systems, sensor systems, or weapon systems; and the estimate includes a forward fit estimate and a retro fit estimate.

17. The cost estimate tool of claim 10, wherein a cost entry screen comprises an input field for receiving a level of confidence for a cost estimate.

18. The cost estimate tool of claim 10, wherein when a plurality of funding sources are input into the requirements screen, at least one of the plurality of cost entry screens includes a table for estimating costs by funding source.

19. A non-transitory machine-readable storage medium encoded with instructions executable by a processor, the non-transitory machine-readable storage medium comprising:
instructions for receiving an indication of a requirement time frame, one or more applicable acquisition programs, and one or more work locations;
instructions for documenting a source of the requirement;
instructions for documenting a funding source for the requirement;
instructions for generating one or more plans based on the time frame, applicable acquisition programs, and work locations, each plan requesting a non-cost estimate and information to support the estimate;
instructions for receiving input into each of the generated plans;
instructions for generating a plurality of cost entry sheets based on the time frame, applicable acquisition programs, and the received plan input;
instructions for receiving cost estimates from the cost entry sheets; and
instructions for generating an estimate of expenses applied to the funding source during the time frame.

20. The non-transitory machine-readable storage medium of claim 19, wherein the input plans include at least one of: a manpower plan, an installation plan, a training system plan, a test and evaluation plan, and a logistics plan.

21. The non-transitory machine-readable storage medium of claim 19, wherein the input plan includes selectable training for entering a cost estimate or information to support the estimate.

22. The non-transitory machine-readable storage medium of claim 19, further comprising instructions for dynamically customizing at least one of the plans based on input received into the at least one plan.

23. The non-transitory machine-readable storage medium of claim 19, further comprising:
instructions for establishing permission for a plurality of users allowed to edit a requirement estimate;
instructions for receiving input from the plurality of allowed users; and
instructions for combining the input from the plurality of allowed users to generate a single estimate.

24. The non-transitory machine-readable storage medium of claim 19, further comprising instructions for storing a plurality of versions of the cost estimate for a requirement.

25. The non-transitory machine-readable storage medium of claim 19, wherein at least one of the acquisition programs is directed to acquisition of aircraft models, aircraft sub-components, avionics systems, sensor systems, or weapon systems; and the estimate includes a forward fit estimate and a retro fit estimate.

26. The non-transitory machine-readable storage medium of claim 19, further comprising instructions for receiving a level of confidence for a cost estimate.

27. The non-transitory machine-readable storage medium of claim 19, further comprising instructions for documenting a plurality of funding sources for the requirement, wherein at least one of the plurality of cost entry sheets includes a table for estimating costs by funding source.
